(19) United States
(12) Patent Application Publication
(10) Pub. No.: US 2001/0029967 A1
(43) Pub. Date: Oct. 18, 2001

(54) Glass-ceramic surface cleaning and polishing system and processes of using the same

(75) Inventor: Thomas J. McDonough, Simpsonville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Foam Partner/Swisstex, Inc.

(21) Appl. No.: 09/756,545

(22) Filed: Jan. 8, 2001

Related U.S. Application Data
(60) Provisional application No. 60/174,855, filed on Jan. 7, 2000.

(51) Int. Cl. A47L 13/16; B08B 1/00

(52) U.S. Cl. 134/6; 15/118; 15/244.3; 15/244.4

(57) ABSTRACT

A cleaning system for cleaning glass ceramic surfaces includes a combined scrubber/applicator pad. The combined scrubber/applicator pad has opposing surfaces having differential surface properties. The system further optionally includes a polishing/buffer pad.

### CROSS-REFERENCE TO RELATED APPLICATIONS

This application is related to provisional application Ser. No. 60/174,855, filed Jan. 7, 2000, which is incorporated herein in its entirety by reference thereto, and claims the benefit of its earlier filing date under 35 USC 119(e).

### FIELD OF THE INVENTION

The present invention is directed to cleaning systems that are particularly advantageous for use with glass-ceramic surfaces, as well as processes of using the same

### BACKGROUND OF THE INVENTION

The thermal endurance and stability offered by glass-ceramics makes these materials useful in many diverse products. For example, stoves having glass-ceramic cooking surfaces are becoming increasingly popular. Generally glass-ceramic cooking appliances include radiant heating elements under a smooth glass-ceramic cooktop or can be incorporated with gas burners. Such appliances can offer almost instant heat, uniform cooking and fast boil times. The heat is directed straight up so only the cooking zone gets hot. Further, the cooking surfaces offer a low profile and uncluttered surface.

Despite the advantages of such appliances, it can be difficult to clean and maintain the polished surface. Currently recommended cleaning procedures include the use of a wet cloth, such as a paper towel and a scraper blade. However, wiping stains and cooked on spills with a cloth or blade, even using specially formulated cleaners for glass-ceramic surfaces, can be time consuming, labor intensive and inefficient. Furthermore abrasive pads (such as but not limited to nonwoven pads) and/or powdered cleaners cannot be used to lessen the time and effort in cleaning because such abrasive cleaning agents can scratch the surface. Scraping more difficult to remove residues with a razor blade is also currently recommended, but with poor perception. There are safety concerns associated with the use of a razor blade, as well as the potential to also damage the surface.

U.S. Pat. No. 5,836,034 to Galvan Garza is directed to a combined soft/abrasive cleaning sponge. The sponge includes a “soft” face and an “extremely abrasive” face. In addition, the sponge includes a plurality of projecting salients in a zig-zag pattern, which are also abrasive on one end and soft on another end. The term “abrasive” is recognized in the art to include materials that typically include particulates or grit. Abrasive materials, however, can scratch the surface to the cleaned and thus are unsuitable for many applications.

U.S. Pat. No. 3,861,993 to Guthrie is directed to a composite foam scouring pad. The pad includes a reticulated hydrophilic crosslinked polyurethane foam layer and a nonreticulated hydrophilic crosslinked foam layer. The reticulated foam is prepared by reacting an isocyanate capped polyoxyethylene polyol with a reaction functionality greater than 2 with an aqueous reactant in the presence of a blowing agent and nonionic surfactant. Many crosslinked foam materials can be relatively inflexible, depending upon the degree of crosslinking. In addition, the Guthrie patent is directed to a reticulated foam material scrubbing surface. As used in the art, the term “reticulated” foam refers to a material in which the cell walls are substantially removed, leaving only interconnecting strands.

U.S. Pat. No. 5,640,737 to Boggs is directed to a multi-component sponge which includes a central or main layer of a reticulated single cell polyurethane flexible foam and outer foam layer(s) adhered to the surface(s) of the reticulated single cell foam layer. The outer foam layers can be polyurethane flexible foams having a reticulated double cell structure and a porosity of 3 to 110 pores per inch. The inner foam layer has a porosity of 3-30 pores per inch. The sponge is intended for personal care use so the outer foam layers are softer than the inner foam layer.

### SUMMARY OF THE INVENTION

The present invention provides a simplified system useful for cleaning and maintaining the appearance of glass ceramic surfaces, such as used in glass ceramic stovetops. In the invention, a combined scrubbing/applicator pad is provided having differential textures on opposing planar surfaces thereof.

The combined scrubbing/applicator pad includes an applicator layer formed of a flexible, compressible plastic foam material. The applicator layer is formed of a generally stiff foam having a relatively high number (or density) of pores per inch, for example, at least about 65 pores per inch. This surface can be particularly useful for applying a cleaning formulation to a surface that is readily scratched by abrasive cleaners and/or pads, such as but not limited to ceramic glass surfaces.

The combined scrubbing/applicator pad also includes a scrubber layer formed of a flexible, compressible plastic foam material. The scrubber layer is selected so as to have a coarse surface texture relative to the surface texture of the applicator. The scrubber layer foam can also be described as an “aggressive” scrubbing surface. Although aggressive, the scrubbing layer will not scratch the surface. Generally the coarser surface is determined by comparing the density of pores per inch along the surfaces of the respective layers. In this regard, the scrubber surface has a lower average number of pores per inch, as compared to the applicator surface material. Stated differently, the scrubber surface of the combined pad can be described as having an average pore size that is larger than the average pore size of the applicator surface.

The scrubber layer may be attached directly to the applicator layer. Alternatively, the combined pad may optionally include an inner flexible, compressible plastic foam layer sandwiched between and adhered to each of the applicator layer and the scrubber layer so as to form a unitary pad having opposing applicator and scrubber surfaces. In one advantageous embodiment, the inner core layer is more flexible and compressible than at least one, and preferably both, of the outer layers. The inner core can support the outer applicator and scrubber layers and further can provide a griping surface for the user. Generally the inner support and gripping layer is softer to the touch and more compressible (less stiff), as well as more absorbent, as compared to at least the scrubber surface of the combined pad. Further, the pad can also include substantially parallel grooves on opposite peripheral edges of the inner layer to further improve ease of use and comfort to the user.

The relatively large pore size of the foam of the scrubber surface can function to contain particulates removed from the glass-ceramic surface away from the outermost surface of the foam which forms the working surface of the scrubber. This in turn can minimize or eliminate the possibility of particulates scratching or marring the glass-ceramic surface. The large pore size can also permit the ready flow of water in and out of the combined pad structure, which can also assist in removing and directing particulates away from the ceramic glass surface. Yet although the scrubber surface is aggressive (has a relatively coarse or rough feel), the relatively forgiving nature of the plastic foam material allows cleaning the glass-ceramic surface without scratching the glass-ceramic surface or damaging or removing frit enamel decoration on the surface.

Thus the present invention minimizes or eliminates the need to use abrasive pad (such as nonwovens or others) and/or powdered cleaners. The invention also eliminates or minimizes the need to scrap residues with a razor blade.

### BRIEF DESCRIPTION OF THE DRAWINGS

Having thus described the invention in general terms, reference will now be made to the accompanying drawings, which are not necessarily drawn to scale, and wherein:

FIG. 1 is a schematic perspective view of an exemplary scrubber/applicator pad in accordance with the cleaning system of the invention; and

FIG. 2 is a top plan view of an exemplary buffer or polishing pad in accordance with the cleaning system of the invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is directed to cleaning systems particularly advantageous for use with glass-ceramic surfaces, including glass-ceramic cooktops. The cleaning system can be used with other easily scratched surfaces as well. The cleaning system of the invention can effectively clean and protect glass-ceramic surfaces while enhancing the appearance, service life, ease of care, and consumer confidence in the care and use of glass-ceramic products.

One aspect of the invention is directed to a new cleaning system product. Generally the cleaning system of the invention can include at least one scrubber/applicator pad and optionally at least one polishing/buffer pad. Various plastic foams can be used to make both the scrubber/applicator pad and the polishing/buffer pad, including but not limited to foams of polyurethane, polyester, polyether, polyester-based polyurethane, polyether-based polyurethane or polyolefins, e.g., polypropylene. Preferably the pads are formed of polyester-based polyurethane prepolymer foam pads. The polyurethane foam can be, but is not limited to, a substantially non-reticulated closed cell foam.

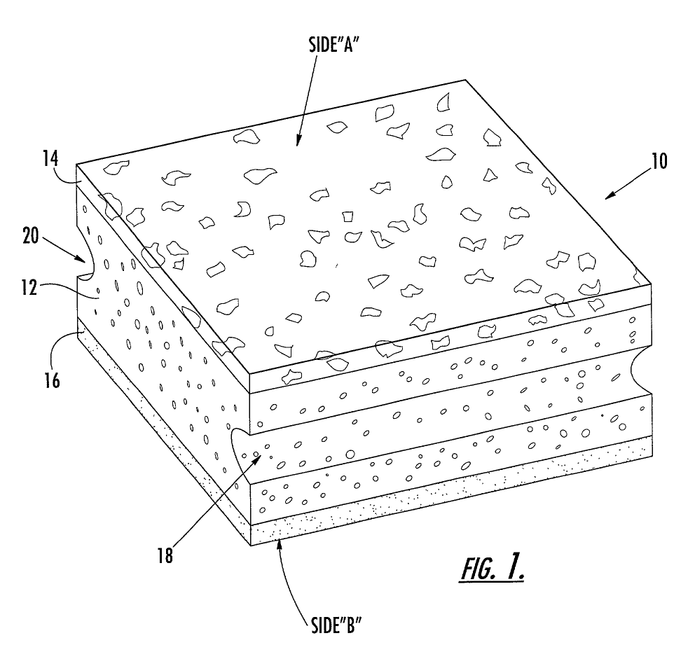

A schematic perspective view of an exemplary scrubber/applicator pad, designated generally as 10, is illustrated in FIG. 1. Scrubber/applicator pad 10 advantageously has a generally rectangular cross-sectional shape. However, as will be appreciated by the skilled artisan, the scrubber/applicator pad can have other shapes, such as but not limited to oval, circular, etc. The pad as illustrated also includes three layers, as discussed in more detail below. However, as the skilled artisan will appreciate, the pad of the invention may include two layers (namely a scrubber layer and applicator layer as described below) or may include more than two layers.

The scrubber/applicator pad 10 as illustrated in FIG. 1 includes an inner foam core 12 sandwiched between and bonded to outer foam layers 14 and 16. The inner foam layer 12 supports the outer layers 14 and 16 and provides a gripping surface for the user. Advantageously the inner foam layer 12, when present, is thicker than the outer foam layers 14 and 16. However, the invention is not so limited and the respective layers of the pad can be of varying thickness relative to one another.

The presence of an inner foam layer can provide various advantages. Generally the inner foam layer has a porosity intermediate the porosity of the outer foam layers. As noted above, the inner foam layer can also be thicker than the outer foam layers 14 and 16. In addition, the foam used to make the inner core layer is generally softer to the touch than at least one, and preferably both, of the outer foam layers (and in particular the scrubber surface as described in more detail below). The foam of the inner foam core can also be less stiff and more easily compressed than at least one, or both, of the foams used to form the outer surfaces of the pad. This can permit the user to better and more comfortably grip the pad. The foam can also be more absorbent relative to one or both of the outer layers, and in particular as compared to the scrubber layer. Further the inner core foam structure can have parallel grooves 18 and 20 on opposite sides of the core to assist the user to grip the pad. Foam core 12 can be non-reticulated closed cell foam as well although it is not limited to such structures.

Outer foam layers 14 and 16 have opposing foam surfaces, designated as “A” and “B,” respectively, in FIG. 1. Foam layers 14 and 16 have differential surface characteristics. In this regard, at least one surface of the scrubber/applicator pad (designated as “A”) has a generally coarser touch or feel relative to the opposing surface (designated as “B”). Despite its coarser surface texture, however, side A of the scrubber/applicator pad is still formed of a flexible, compressible plastic, which is forgiving and thus allows application of force when using the same to scrub a glass-ceramic surface without scratching or marring that surface. This is in contrast to conventional abrasive foam scrubbers which typically include grit or other particulates to provide an adequate scrubbing surface. Abrasive foams, however, can scratch glass ceramic surfaces and thus are not useful for such applications.

Each of the scrubber and applicator foam layers are formed of flexible foams. The term “flexible” as used herein refers to foams that are resilient and can compress without damage to the foam structure when a load is applied to the foam. The flexible foams will also typically bounce or spring back to their original size and shape after the load is removed, even after several repetitions of applying and removing a load. This is in contrast to rigid or semi-rigid foams that will either not compress without damage to the foam structure when a load is applied to the foam or will not bounce back to their original size and shape after the load has been removed (especially if the load is applied and removed more than once).

The differential surface characteristics of sides A and B of the scrubber/applicator pad can be described in terms of the relative number of pores per inch of the respective foam components. The scrubber side (side A) generally has a medium to coarse texture, advantageously from about 10 to about 15 pores per inch. The porosity of the scrubber surface can fall outside this range, so long as the scrubber side has a smaller average number of pores per inch as compared to the applicator surface. In this regard, the opposing applicator side (side B) has a relatively fine texture, and advantageously at least about 65 pores per inch. Again the applicator surface can have fewer than 65 pores per inch, so long as the average number of pores per inch is greater than that of the scrubber surface.

Advantageously foam layer 14 may also have the following non-limiting properties: density of about 2.40 lb/ft³; tensile strength of 30.00 psi; and elongation of about 80%. Advantageously foam layer 16 of the pad may be formed of a foam having the following non-limiting properties: density of about 2.81 lb/ft³; tensile strength of about 75.42 psi; and elongation of 230%.

The respective polyurethane foams used to make core 12 and layers 14 and 16 are commercially available. In one currently preferred embodiment of the invention, the foam forming surface A is available from Foam Partner/Swisstex, Inc. of Greenville, S.C., under the trade designation “PPM-10”, and the foam forming surface B is also commercially available from Foam Partner/Swisstex, Inc. under the trade designation “V8 FEIN.” The core foam 12 may also be a polyurethane foam, such as available from Foam Partner/Swisstex, Inc.

Generally the polyurethane foam can be formed in the conventional polyurethane foaming technique wherein the reactants of a polyol, such as polyester or polyether bearing reactive hydroxyl groups, and an isocyanate, such as tolylene diisocyanate, and a blowing agent, e.g., water, are admixed in a vessel and react therein under conditions to form a foam. Reaction conditions are controlled to impart the desired properties, such as porosity, density, and the like, to the respective foam components of the multi-component scrubber/applicator pad as well as the buffer pad as described below.

Suitable polyester polyols include those produced from polycarboxylic acids such as succinic acid, adipic acid, phthalic acid and isophthalic acid. The polyhydric initiator used in preparing the polyol reactant can include: (a) aliphatic diols, such as ethylene glycol, 1,3-propylene glycol, butylene glycols, butane diols, pentane diols, and the like; (b) aliphatic triols, such as glycerol, trimethylol-propane, triethylolpropane, trimethylolhexane, and the like; and (c) higher functionality alcohols, such as sorbitol, pentaerythritol, methyl glucoside, polytetramethylene glycol and the like.

Suitable organic polyisocyanates include aromatic, cycloaliphatic and aliphatic polyisocyanates. Aromatic polyisocyanates such as 4,4′-diphenylmethane diisocyanate (MDI) and isomeric mixtures with 2,4′-diphenylmethane diisocyanate and 2,2′-diphenylmethane diisocyanate, as well as polymeric MDI products derived from the reaction of phosgene with an aniline-formaldehyde condensate may be employed. Other aromatic polyisocyanates which can be used include toluene diisocyanates such as the 80:20 and the 65:35 mixtures of 2,4- and 2,6-isomers, xylene diisocyanate, 3,3′-bitoluene-4,4′diisocyanate and naphthalene-1,5-diisocyanate. Cycloaliphatic polyisocyanates which can be employed as reactants include methylene bis(4-cyclohexyl)isocyanate and isophorone diisocyanate. Aliphatic polyisocyanates which can be used in the prepolymer products include ethylene diisocyanate, propylene diisocyanate, and hexamethylene diisocyanate.

The foam layers can be joined by any suitable means, for example using an adhesive bonding agent, thermal fusion, and the like.

The relatively large pore size of the foam of side A can provide an open cell-like structure and texture to the scrubber surface. This can function to contain particulates removed from the glass-ceramic surface away from the outermost surface of the foam which forms the working surface of the scrubber, thereby minimizing or eliminating the possibility of particulates scratching or marring the glass-ceramic surface. Thus it is currently believed that the relatively open cell-like structure and texture of the foam of side A allows the passage of particulates from a glass-ceramic surface into the foam, as well as water, to readily flow into the foam material. In addition, while the side A polyurethane foam material is aggressive (coarse or rough feel), the relatively forgiving nature of the polyurethane foam material allows cleaning the glass-ceramic surface without scratching the glass-ceramic surface or damaging or removing frit enamel decoration on the surface. The scrubber is intended to replace the need for a steel scraper blade, blue Scotch-Brite scrubbing pads, and any other scrubber currently used to remove baked on food or other removable residuals from the cooktop surface.

The opposing applicator side B is designed to remove residuals from the scrubbing application, apply approved glass-ceramic cooktop cleaning and protection creams to the surface, and clean the RTV seal bordering the glass-ceramic surface and steel frame.

To summarize, this product can provide a total cleaning process, including scrubbing, cleaning, cream application and/or polishing of a surface with one product.

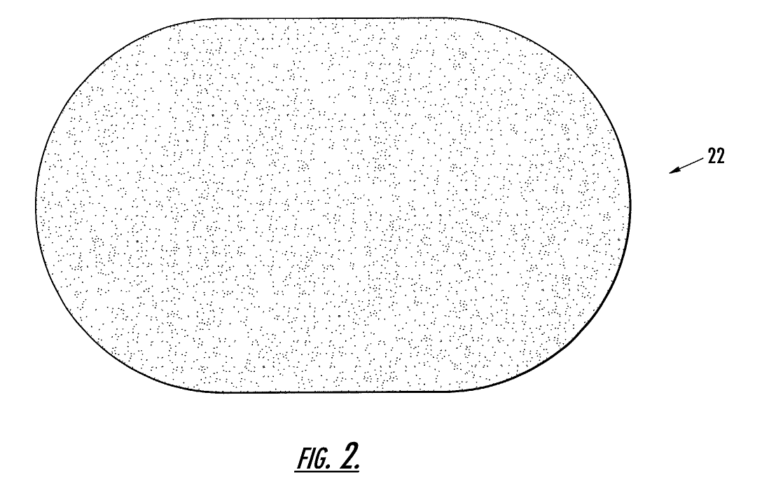

Turning to FIG. 2, a top plan view of an exemplary buffer or polishing pad 22 in accordance with the cleaning system of the invention is illustrated. As shown, advantageously the buffer has a generally oval cross-section, although other cross sectional configurations and thickness can be used. Generally the buffer pad is designed to buff the surface and restore a brilliant shine. The buffer pad also is preferably formed of a polyester-based polyurethane prepolymer foam, although other plastic foams can be used. The buffer pad generally has a fine, smooth surface, and advantageously has at least about 65 pores per inch. The porosity of the buffer can also vary. The buffer or polishing pad of FIG. 2 is also commercially available, for example, under the trade designation V65 FEIN also from Foam Partner/Swisstex, Inc. Advantageously the buffer pad has the following non-limiting properties: density of about 2.75 lb/ft³; tensile strength of 72.52 psi; and elongation of about 440%.

Both the two-sided scrubber/applicator pad and the buffer/polishing pad are intended to be used in conjunction with approved glass-ceramic cleaning creams, which are already on the market.

The present invention also provides a process for cleaning glass-ceramic surfaces, including glass-ceramic cooktops. In the process of the invention, the scrubber/applicator pad can be moistened and excess water squeezed out. Stains, baked on food, and the like are removed by scrubbing using the scrubber side A. Approved liquid cleaners can be used to assist the cleaning process. The applicator side B can be used to remove excess water, food and any applicable cleaner from the surface. The pad should be rinsed out as necessary. Next, the applicator side B can be used to apply approved cleaning creams. The buffer pad is used (dry) in a circular and/or reciprocating motion to remove the excess cream and restore a brilliant shine. Finally, the edge of the scrubber/applicator pad can be used to clean residuals from the RTV seal between the surface and steel frame.

The cleaning system and process of the invention can provide several advantages:

1. This system is designed to eliminate the need for: a steel scraper blade, scrubbing pads (nonwoven or other), towels, sponges, paper towels, or other cloth materials.

2. The invention can provide consumer confidence when scrubbing without need of a steel blade.

3. The invention can eliminate safety concerns presented by steel blade (use and storage).

4. The invention can use attractive, dedicated products to enhance the high quality image of glass-ceramic cooktops.

5. The invention is easy to use. The pads fit well in hand and are easy to grip without tiring.

6. The invention provides the convenience of a “all-in-one” product that is also easy to organize in storage.

7. The process is simple and includes sequential operations.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A combined scrubbing/applicator pad useful for cleaning ceramic glass surfaces, comprising:
an applicator layer formed of a flexible compressible plastic foam material;
a scrubber layer formed of a flexible compressible plastic foam material having a coarse surface texture with a larger average pore size than the applicator layer; and
an inner flexible compressible plastic foam support and gripping layer, which is less stiff than at least one of the applicator layer and the scrubber layer, sandwiched between and adhered to each of said applicator layer and said scrubber layer to form a unitary pad having opposing applicator and scrubber surfaces.

2. The pad of claim 1, wherein the inner foam layer has an average pore size intermediate the average pore size of said applicator layer and said scrubber layer.

3. The pad of claim 1, wherein the applicator layer has a porosity of at least about 65 pores per inch.

4. The pad of claim 3, wherein the scrubber layer has a porosity ranging from about 10 to about 15 pores per inch.

5. The pad of claim 1, wherein the scrubber layer has a substantially open cell structure on the exposed surface so as to allow the passage of particles and water into the pad.

6. The pad of claim 1, wherein each of said foam layers are formed of a foam selected from the group consisting of polyurethane, polyester, polyether, and polyolefin foam and mixtures thereof.

7. The pad of claim 6, wherein each of said foam layers are polyurethane foams.

8. The pad of claim 7, wherein said scrubber layer is formed of a polyurethane prepolymer foam.

9. The pad of claim 8, wherein said applicator layer is also formed of a polyurethane prepolymer foam.

10. The pad of claim 1, wherein each of said scrubber layer and said applicator layer are formed of substantially non-reticulated foam.

11. The pad of claim 1, wherein said pad includes peripheral edges and wherein said inner layer further comprises first and second substantially parallel grooves on opposite peripheral edges thereof.

12. A combined scrubbing/applicator pad useful for cleaning ceramic glass surfaces, comprising:
an applicator layer formed of a flexible compressible plastic foam;
a scrubber layer formed of a flexible compressible polyester-based polyurethane prepolymer foam having a coarse surface texture with a larger average pore size than the applicator layer; and
an inner flexible compressible plastic foam support and gripping layer sandwiched between and adhered to each of said applicator layer and said scrubber layer to form a unitary pad having opposing applicator and scrubber surfaces.

13. The pad of claim 12, wherein said inner layer is less stiff than at least one of the applicator layer and the scrubber layer.

14. The pad of claim 12, wherein said applicator layer is also formed of a polyurethane prepolymer foam.

15. The pad of claim 12, wherein the applicator layer has a porosity of at least about 65 pores per inch and wherein the scrubber layer has a porosity ranging from about 10 to about 15 pores per inch.

16. The pad of claim 15, wherein each of said scrubber layer and said applicator layer are formed of substantially non-reticulated foam.

17. The pad of claim 12, wherein said pad includes peripheral edges and wherein said inner layer further comprises first and second substantially parallel grooves on opposite peripheral edges thereof.

18. A combined scrubbing/applicator pad useful for cleaning ceramic glass surfaces, comprising:
an applicator layer formed of a flexible compressible plastic foam material; and
a scrubber layer formed of a flexible compressible polyester-based polyurethane prepolymer foam material having a coarse surface texture with a larger average pore size than the applicator layer.

19. The pad of claim 18, wherein said applicator layer is also formed of a polyurethane prepolymer foam.

20. The pad of claim 18, wherein the applicator layer has a porosity of at least about 65 pores per inch and wherein the scrubber layer has a porosity ranging from about 10 to about 15 pores per inch.

21. The pad of claim 20, wherein each of said scrubber layer and said applicator layer are formed of substantially non-reticulated foam.

22. A process for cleaning a surface that is easily scratched by conventional abrasive cleaning agents, wherein the process uses a combined scrubbing/applicator pad having an applicator surface and a scrubber surface, the scrubber surface having a coarser surface texture than the applicator surface and is capable of scrubbing the easily scratched surface without substantial scratching, the process comprising:
scrubbing the easily scratched surface with the scrubber surface of the pad to remove debris therefrom;
applying a non-abrasive cleaning agent to the easily scratched surface with the applicator surface of the pad; and
removing debris, water and/or cleaning agent from the easily scratched surface with the applicator surface of the pad.

23. The process of claim 22, wherein the surface to be cleaned is a glass ceramic surface.

24. The process of claim 22, wherein each of said applicator surface and said scrubber surface are formed of a flexible compressible plastic foam material.

25. The process of claim 24, wherein the scrubber surface is formed of a polyester-based polyurethane prepolymer foam material having a larger average pore size than the applicator surface.

26. The process of claim 25, wherein the applicator surface has a porosity of at least about 65 pores per inch and wherein the scrubber surface has a porosity ranging from about 10 to about 15 pores per inch.

27. The process of claim 26, wherein each of said scrubber surface and said applicator surface are formed of substantially non-reticulated foam.

28. The process of claim 27, wherein said applicator/scrubber pad further includes an inner flexible compressible plastic foam support and gripping layer sandwiched between and adhered to each of said applicator layer and said scrubber layer to form a unitary pad having opposing applicator and scrubber surfaces.

29. The process of claim 28, wherein said inner layer is less stiff than at least one of the applicator surface and the scrubber surface.

30. The process of claim 29, wherein said pad includes peripheral edges and wherein said inner layer further comprises first and second substantially parallel grooves on opposite peripheral edges thereof.
